(19) United States
(12) Patent Application Publication
(10) Pub. No.: US 2006/0134504 A1
(43) Pub. Date: Jun. 22, 2006

(54) Fuel cell in which a fluid circulates essentially parallel to the electrolytic membrane and method for production of such a fuel cell

(75) Inventor: Jean-Yves Laurent, Claix (FR)

Correspondence Address: OLIFF & BERRIDGE, PLC, P.O. BOX 19928, ALEXANDRIA, VA, 22320, US

(73) Assignee: Commissariat A L'energie Atomique, Paris (FR)

(21) Appl. No.: 10/560,586

(22) PCT Filed: Jun. 18, 2004
(86) PCT No.: PCT/FR04/01525

§ 371 Date: Dec. 13, 2005

(30) Foreign Application Priority Data
Jul. 1, 2003 (FR) 03/07961

(51) Int. Cl. H01M 8/02; H01M 8/10; B05D 5/12; C03C 25/68

(52) U.S. Cl. 429/39; 429/30; 427/115; 216/58

(57) ABSTRACT

The invention relates to a fuel cell, comprising a substrate supporting an electrolytic membrane with first and second faces on which first and second electrodes are respectively arranged. The first and second electrodes respectively comprise first and second catalytic elements and first and second fluids are respectively provided for supply to the neighbourhood of the first and second catalytic elements. The supply of the first fluid on the neighbourhood of the first catalytic element is embodied such as to generate a circulation essentially parallel to the first face of the electrolytic membrane, in a cavity formed in the substrate.

### BACKGROUND OF THE INVENTION

The invention relates to a fuel cell, and more particularly a micro fuel cell, comprising a substrate supporting an electrolytic membrane comprising first and second faces on which first and second electrodes are respectively arranged, the first and second electrodes respectively comprising first and second catalytic elements, circulation means being designed to bring first and second fluids respectively in proximity to the first and second catalytic elements.

The invention also relates to a method for production of such a fuel cell.

### STATE OF THE ART

In fuel cells, providing the electrodes with reactive fluid and removing the products formed when the cell operates represent two major difficulties, in particular in micro fuel cells used in portable equipment. Miniaturization of fuel cells does in fact impose storage and a circulation circuit for the fuel, the combustive-fuel and the products formed in the course of operation of the cell, in very small volumes.

The fuels used in microcells are generally in liquid form. As liquid fuels have a higher energy volume density than that of hydrogen, they occupy a smaller volume than hydrogen. Thus, it is commonplace to use fuel cells using methanol as fuel, these cells being better known under the name of DMFC (Direct Methanol Fuel Cells). The methanol is oxidized at the anode, on an active catalytic layer, to give protons, electrons and carbon dioxide. A proton conducting membrane arranged between the anode and a cathode conducts the protons to the cathode so as to make the protons react with oxygen and form water. The carbon dioxide and water forming respectively at the anode and the cathode when the cell operates therefore have to be removed.

In general manner, it is known to use supply circuits of the electrodes and of the electrolytic membrane. The circuits are generally in the form of supply channels and/or microporous diffusion layers performing supply of the fluids perpendicularly to the electrodes or to the membrane.

Thus, the document FR-A-2,814,857 describes a micro fuel cell comprising an oxygen electrode and a fuel electrode, the fuel preferably being formed by a mixture of methanol and water. A microporous support impregnated with an electrolytic polymer forming an electrolytic membrane is arranged between the two electrodes. The microporous support is formed by an oxidized semi-conducting material made porous to form channels parallel to one another. The channels enables electrochemical exchanges to be made between the anode and cathode. The microporous support is supplied with fuel and with combustive-fuel by diffusion channels respectively connected to a fuel source and an air source.

It is also known to use a porous diffusion layer to supply an electrode with reactive fluid, as represented in FIG. 1. Thus, a fuel cell 1 comprises a substrate 2 supporting an anode 3, an electrolytic membrane 4 and a cathode 5. An anodic current collector 6 is arranged on the anode 3 and circulation of the fuel is tangential to the anode 3. Air supply to the cathode is performed by means of circulation channels 7 formed vertically in the substrate. The circulation channels 7 therefore enable air to be transported from an air source (not represented) to a microporous diffusion layer 8 arranged between the cathode 5 and a current collector 9. A fuel cell of this kind has been described in the document WO-A-0,045,457. The fuel cell thus comprises a substrate supporting first and second electrodes between which an electrolytic membrane is arranged. Supply of the first electrode with reactive fluid is performed by a porous thin layer arranged between the first electrode and a substrate. Said substrate comprises vertical diffusion channels connected to a cavity itself supplied by a fuel source. This type of reactive fluid supply is however not satisfactory. The residual fluids such as water forming at the cathode in the fuel cell 1 are in fact removed by the same circulation channels as the reactive fluid such as the air in the fuel cell 1, in the opposite direction. Making two opposite flows circulate in a circulation channel having a relatively small diameter limits the access of the reactive fluids to the cathode.

### OBJECT OF THE INVENTION

It is an object of the invention to remedy these shortcomings and more particularly to propose a fuel cell enabling both efficient and quick removal of the compounds formed when operating and enabling the reactive fluids to be quickly renewed.

According to the invention, this object is achieved by the fact that the circulation means of the first fluid are designed in such a way as to make the latter flow in a direction substantially parallel to the first face of the electrolytic membrane, in a cavity formed in the substrate.

According to a development of the invention, the cavity comprises a plurality of studs supporting said electrolytic membrane.

According to a preferred embodiment, the first catalytic element is formed by a plurality of catalytic zones respectively arranged at the top of the studs of the cavity.

According to another preferred embodiment, the first catalytic element is formed by a plurality of catalytic zones, said catalytic zones being respectively formed by the studs.

It is a further object of the invention to provide a method for production of such a fuel cell that is easy to implement and using techniques implemented in the microtechnology field.

According to the invention, this object is achieved by the fact that the method for production consists in performing reactive ion etching in the substrate so as to form the cavity and the plurality of studs at the same time.

According to a development of the invention, the method for production consists in depositing on the top of each stud, by physical vapour deposition, a growth promoting substance designed to foster formation of a catalyzer support whereon a catalytic layer is deposited by electroplating.

According to the invention, this object is also achieved by the fact that the method for production consists in etching the cavity in the substrate and in then forming the plurality of studs by electrolytic growth.

### BRIEF DESCRIPTION OF THE DRAWINGS

Other advantages and features will become more clearly apparent from the following description of particular embodiments of the invention given as non-restrictive examples only and represented in the accompanying drawings, in which:

FIG. 1 represents in cross-section a fuel cell of the prior art.

FIG. 2 is a cross-sectional view of a particular embodiment of a fuel cell according to the invention.

FIG. 3 represents an overall view of a part of the fuel cell according to FIG. 2.

FIG. 4 represents a top view of a cavity of a fuel cell according to the invention.

FIG. 5 represents a top view of the circulation means of a fluid in the fuel cell according to FIG. 1.

FIGS. 6 to 8 illustrate different steps of a first method for production of the catalytic zones in the fuel cell according to FIG. 3.

FIGS. 9 to 14 illustrate different steps of a second method for production of a fuel cell according to the invention.

### DESCRIPTION OF PARTICULAR EMBODIMENTS

A fuel cell according to the invention comprises a substrate supporting an electrolytic membrane comprising first and second faces. First and second electrodes are respectively arranged on the first and second faces of the electrolytic membrane and they respectively comprise first and second catalytic elements designed to trigger an electrochemical reaction. First and second fluids are respectively designed to be brought near to the first and second catalytic elements. Supply of the first fluid is thus performed in such a way as to make the latter flow substantially parallel to the first face of the electrolytic membrane in a cavity formed in the substrate, and to bring it into contact with the first catalytic element. The first fluid associated with the first catalytic element can thus be either the combustive-fuel associated with the catalytic element of the cathode or the fuel associated with the catalytic element of the anode. The cavity formed in the substrate can comprise a plurality of studs supporting the electrolytic membrane.

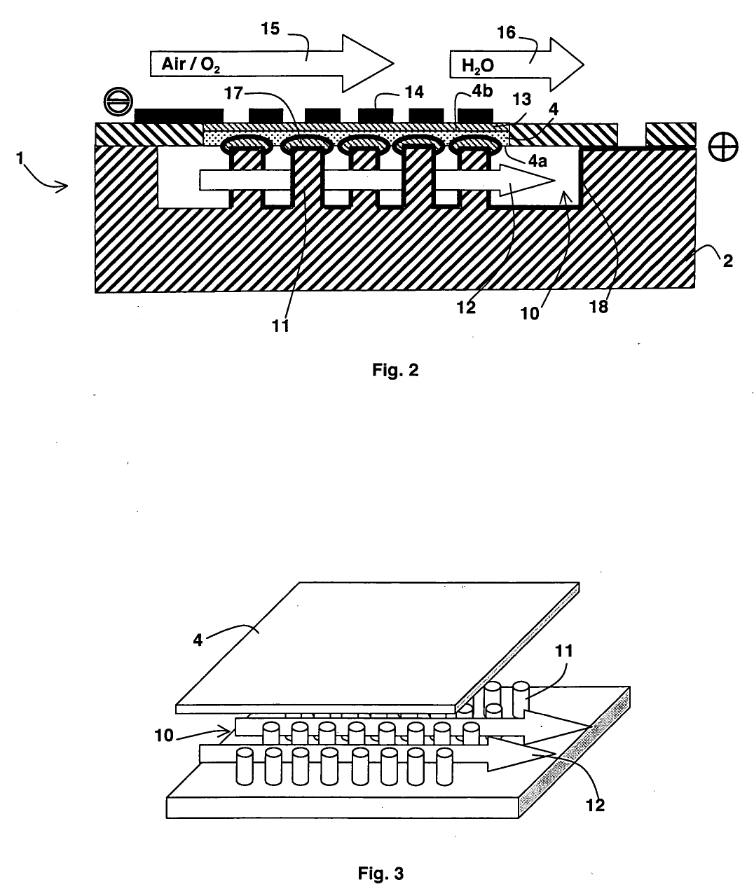

In a particular embodiment represented in FIGS. 2 and 3, a cavity 10 is formed in the substrate 2 of a fuel cell 1 and it comprises a plurality of studs 11. The cavity 10 is designed to bring a first fluid to the proximity of a first electrode and the studs 11 preferably form a network designed to distribute the first fluid homogeneously in the cavity 10. For example, in FIG. 2, the first fluid is a combustible fluid such as a mixture of water and methanol and the first electrode is an anode. Inlet of the combustible fluid to the cavity 10 and outlet thereof from the cavity 10 can be performed by any type of suitable means. For example, the walls of the cavity 10 can be porous or they can comprise inlet and outlet apertures connected to circulation channels or to a fuel source. Thus, the flow of combustible fluid generated in the cavity 10 and represented by an arrow 12 in FIG. 2 moves horizontally in the cavity 10 between the studs 11 and substantially parallel to the first face 4a of the electrolytic membrane 4.

The studs 11 can be of any suitable shape. They can for example have a circular, rectangular or polygonal cross-section. They can also be distributed in the cavity 10 in any kind of arrangement, the studs 11 being able for example to be aligned in several rows or form a zig-zagged network. This arrangement is adjusted so that the combustible fluid can be distributed homogeneously in the cavity 10. The number of studs 11 in the cavity 10 can also be adjusted according to the time the combustible fluid is to spend in the cavity 10. The fuel cell can also comprise means for controlling the combustible fluid flow, so as to adjust the flow time of the combustible fluid in the cavity and therefore the electrochemical reaction time.

The studs 11 preferably have the same dimensions and their height is equal to the depth of the cavity 10. For example, the height of the studs can be 30 micrometers and their diameter can be comprised between 10 micrometers and 40 micrometers for cylindrical studs. In addition, the distance between two studs is preferably less than or equal to 50 micrometers, so that all of the studs 11 can support an electrolytic membrane 4.

The electrolytic membrane 4 comprises first and second faces 4a and 4b, respectively designed to be in contact with the first and second catalytic elements of the first and second electrodes. Thus, the first face 4a of the electrolytic membrane 4 is placed on the studs 11 and the ends of the electrolytic membrane 4 are securedly fixed to the substrate 2. The second face 4b of the electrolytic membrane 4 is covered by a catalytic element 13 in the form of a thin film and a discontinuous current collector element 14, the catalytic element 13 and the current collector element 14 thus forming the second electrode. The fluid associated with the second electrode is, in FIG. 2, a combustive fluid such as air and the second electrode corresponds to the cathode of the fuel cell. The combustive fluid flow is schematized in FIG. 2 by an arrow 15 located above the cathode. Thus, the air flows parallel to the cathode so that the air flow can remove the water produced at the cathode to the outside of the fuel cell (arrow 16) when the fuel cell is operating.

On the top of each stud 11, there is preferably arranged a catalytic zone 17 designed to trigger an electrochemical reaction with the combustible fluid. The set of catalytic zones 17 thus forms the catalytic element of the anode. As the studs 11 support the electrolytic membrane 4, each catalytic zone 17 is in contact with the first face 4a of the electrolytic membrane 4 and a current collector 18 is deposited on the surface of the studs 11 and on the walls of the cavity 10.

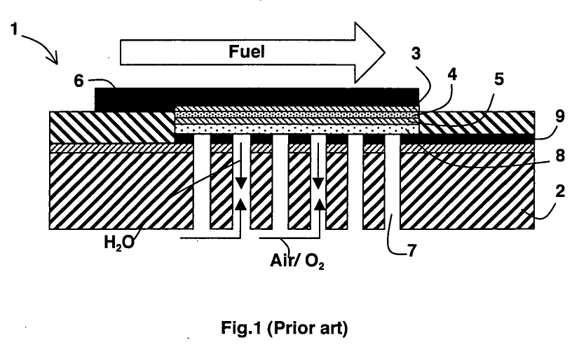

Such a fuel cell enables the combustible fluid to be made to flow substantially parallel to the first face 4a of the electrolytic membrane (FIG. 3). The flow thus created enables the combustible fluid to be renewed at the level of the catalytic zones 17 of the anode. Moreover, unlike a circulation circuit according to the prior art (FIGS. 1 and 5), the products formed at the anode when the fuel cell operates are driven by the flow of combustible fluid. In this way, the products formed do not slow down renewal of combustible fluid to the catalytic zones 17.

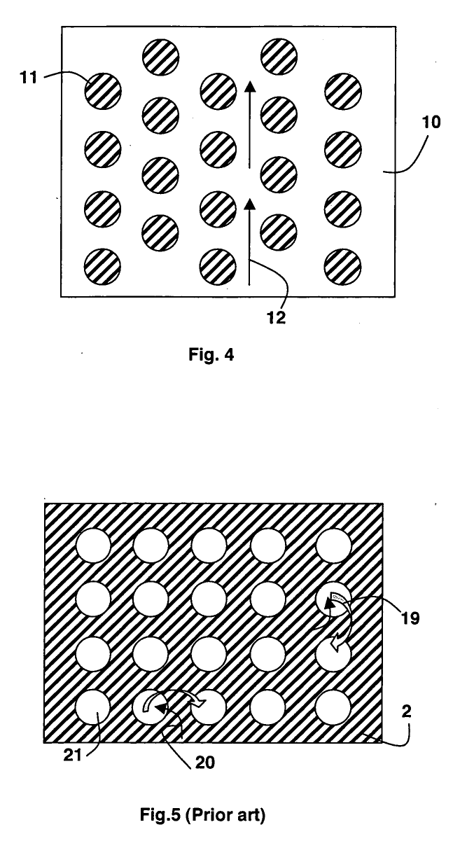

Indeed, in the fuel cell 1 according to FIG. 2, the flow of combustible fluid, represented by the arrow 12 in FIG. 4, circulates between the studs 11 of the cavity 10 and drives with it the residual fluids formed at the anode, such as carbon dioxide for a combustible fluid comprising methanol and water. In a fuel cell according to the prior art on the other hand, the flow of combustible fluid and the flow of residual fluids, respectively represented by the arrows 19 and 20 of FIG. 5, circulate in opposite directions in the same circulation channels 21. The circulation channels 21 are formed in the substrate 2 and transport the flow of combustible fluid perpendicularly to the electrolytic membrane.

According to a particular embodiment of fabrication of the fuel cell 1, reactive ionic etching (RIE) in the substrate 2 enables the cavity 10 and studs 11 to be formed simultaneously. The substrate can be made of silicon, ceramic or plastic. Once the cavity 10 and studs 11 have been formed, physical vapour deposition of platinum is performed on the surface of the studs 11 and on the walls of the cavity 10 so as to form a thin film having a thickness of about one micrometer and forming the current collector 18 of the anode.

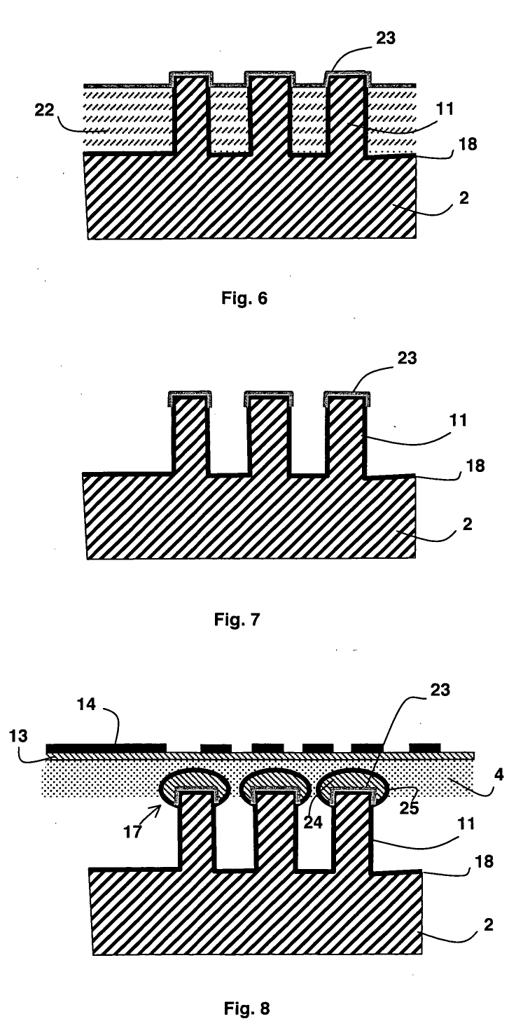

The catalytic zones 17 are then made at the top of the studs 11, as represented in FIGS. 6 to 8. Thus, a layer of protective resin 22 is deposited in the cavity 10 up to a predetermined height so that the top part of the studs 11 is free. Physical vapour deposition of a growth promoting substance 23 is performed in the cavity 10 so as to cover the top part of the studs 11 with protective resin (FIG. 6). After the layer of protective resin 22 has been removed (FIG. 7), only the top parts of the studs 11 are covered with a layer of growth promoting substance 23 designed to foster formation of a catalyzer support 24 at the top of each stud 11. The catalyzer support 24, preferably formed by carbon nanotubes, is then covered with a catalytic active layer 25, by electroplating (FIG. 8). The catalyzer support 24 and the catalytic active layer 25 form a catalytic zone 17 of the catalytic element of the anode.

Once the catalytic zones 17 have been formed, the electrolytic membrane 4, preferably made of Nafion®, is spread by a centrifugation process, also called spin coating, and is then dried. The small space between two studs 11 enables a volume of air to be trapped preventing the still liquid material of the membrane from running before it has dried. The catalytic element of the cathode, preferably formed by a mixture of platinum-plated carbon and Nafion®, is then spread by sputtering on the dried electrolytic membrane 4, then the current collector 14 of the cathode is deposited by physical vapour deposition.

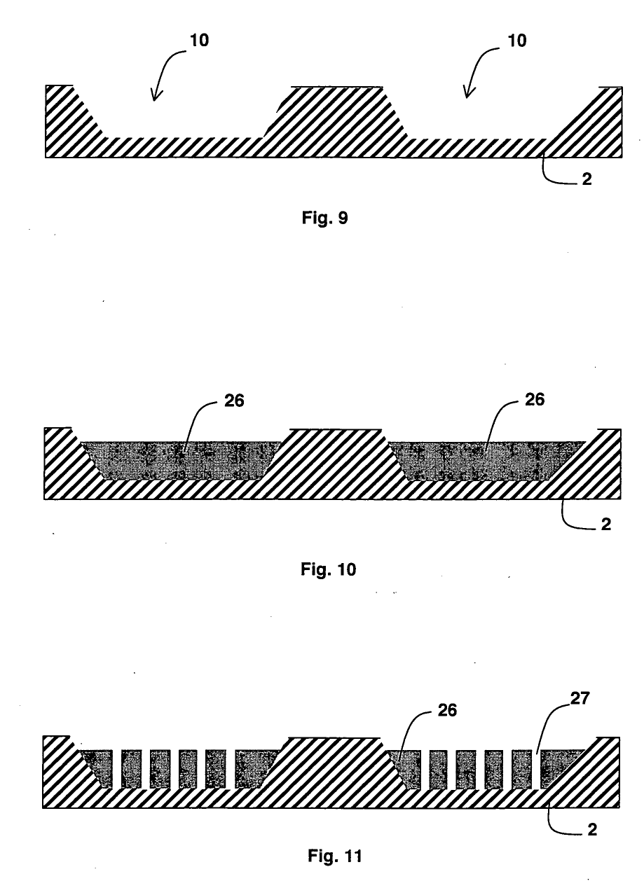

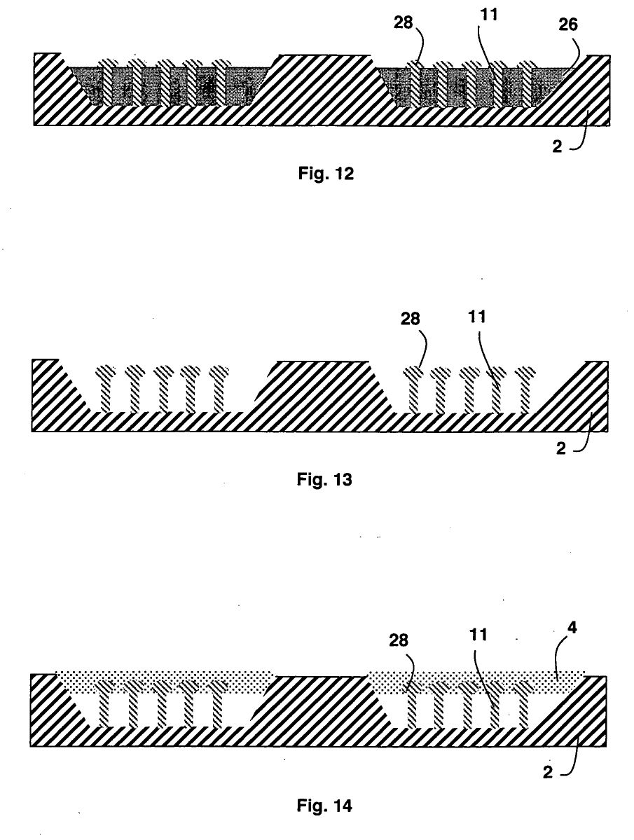

According to an alternative embodiment, the catalytic zones 17 of the catalytic element of the anode can be respectively formed by the studs 11 of the cavity 10. The cavity and studs are then formed successively. Thus, as represented in FIGS. 9 to 14, several fuel cells can be made on the same substrate. Two cavities 10 are etched in the substrate 2 and their walls are metallized (FIG. 9). The studs 11 are then formed by electrolytic growth and a layer of thick resin 26 is deposited in the cavities 10 (FIG. 10). Spaces 27 corresponding to the required position for the studs 11 are created, by lithography, in the resin layer 26 (FIG. 11). Then the studs 11 are formed in the spaces 27 by electrolytic growth of platinum (FIG. 12). The studs 11 preferably comprise, at the top part thereof, a broader zone constituting a head 28. The layer of thick resin 26 is then removed to free the cavities 10 (FIG. 14). A layer designed to form electrolytic membranes 4, preferably made of Nafion®, is deposited above the cavities 10 so that the electrolytic membranes 4 are supported by the studs 11. The catalytic element and the current collector of the cathode are then deposited on the electrolytic membrane by means of any type of known technique.

The invention is not limited to the embodiments described above. Thus, the fluid designed to flow substantially parallel to the first face of the electrolytic membrane in the cavity can be the combustive fluid. Likewise, the catalytic element designed to be in contact with said fluid can be continuous. For example, the catalytic zones constituted by the studs or formed at the top of the studs can be joined so as to obtain a continuous catalytic element. The combustible fluids can be of any type, liquid or gaseous. The fuel cell can more particularly be of the DMFC type and it can also be a micro fuel cell of the same type as those used in portable equipment.

1-14. (canceled)

15. Fuel cell comprising a substrate supporting an electrolytic membrane comprising first and second faces on which first and second electrodes are respectively arranged, the first and second electrodes respectively comprising first and second catalytic elements, circulation means being designed to bring first and second fluids respectively in proximity to the first and second catalytic elements, wherein the circulation means of the first fluid are designed in such a way as to make the latter flow in a direction substantially parallel to the first face of the electrolytic membrane, in a cavity formed in the substrate and comprising a plurality of studs supporting said electrolytic membrane.

16. Fuel cell according to claim 15, wherein the distance between two studs is less than or equal to 50 micrometers.

17. Fuel cell according to claim 15, wherein the first catalytic element is formed by a plurality of catalytic zones respectively arranged at the top of the studs of the cavity.

18. Fuel cell according to claim 15, wherein the first catalytic element is formed by a plurality of catalytic zones, said catalytic zones being respectively formed by the studs.

19. Fuel cell according to claim 18, wherein the studs comprise, at the top part thereof, a broader zone forming a head.

20. Fuel cell according to claim 15, wherein the studs have a circular cross-section.

21. Fuel cell according to claim 15, wherein the studs have a rectangular cross-section.

22. Fuel cell according to claim 15, wherein the studs have a polygonal cross-section.

23. Fuel cell according to claim 15, wherein the studs form a network designed to distribute the first fluid homogeneously in the cavity.

24. Fuel cell according to claim 23, wherein the network is arranged in zig-zagged manner.

25. Method for production of a fuel cell according to claim 15, consisting in performing reactive ionic etching in the substrate so as to simultaneously form the cavity and the plurality of studs.

26. Method for production according to claim 25, consisting in depositing on the top of each stud, by physical vapour deposition, a growth promoting substance designed to foster formation of a catalyzer support whereon a catalytic layer is deposited by electroplating.

27. Method for production according to claim 26, wherein the catalyzer support is formed by carbon nanotubes.

28. Method for production of a fuel cell according to claim 15, consisting in etching the cavity in the substrate and in then forming the plurality of studs by electrolytic growth.
